(19) United States
(12) Patent Application Publication
(10) Pub. No.: US 2010/0315453 A1
(43) Pub. Date: Dec. 16, 2010

(54) COMPLEXED PRINTER AND PRINTING METHOD USING THE SAME

(76) Inventor: Cheol Sik Ok, Yongin-si (KR)

Correspondence Address: KED & ASSOCIATES, LLP, P.O. Box 221200, Chantilly, VA, 20153-1200, US

(21) Appl. No.: 12/740,497

(22) PCT Filed: Oct. 28, 2008
(86) PCT No.: PCT/KR2008/006341

§ 371 Date: Apr. 29, 2010

(30) Foreign Application Priority Data
Oct. 31, 2007 (KR) 10-2007-0110237

(51) Int. Cl. B41J 29/38; B41J 2/01

(52) U.S. Cl. 347/9; 347/16; 347/102

(57) ABSTRACT

The present invention relates to a multifunction printer and a printing method thereof capable of applying a pre-coating prior to printing in order to improve ink adhesion, capable of applying a finish coating after printing an image in order to protect ink and prevent irregular ink reflection, and capable of cutting printed material. For this purpose, a multifunction printer is configured for pre-treatment and configured for finishing treatment, accommodates the addition of other colors through user settings, and has an integrally installed cutter for cutting final printed material, so that printed material with improved ink adhesion and ink durability can be provided regardless of the type of printing material, and scattered reflection of ink can be prevented to provide uniform color reproduction in printed material. Also, because printing and cutting are possible, processing time and manufacturing cost can be reduced, and yield and work environments can effectively be improved.

### TECHNICAL FIELD

The present invention relates to a complexed (multifunction) printer and printing method, and to a multifunction printer and a printing method thereof capable of applying a pre-coating prior to printing in order to improve ink adhesion, capable of applying a finish coating after printing an image in order to protect ink and prevent irregular ink reflection, and capable of cutting printed material.

### BACKGROUND ART

In general, an inkjet printer is a printing machine for printing characters on paper, etc. by discharging ink through a nozzle.

FIG. 1 illustrates an inkjet printer that uses ink according to the related art, and the inkjet printer 10 conveys a printing material 15 such as paper or fabric in a longitudinal direction of a body frame 11, and performs printing by moving a carrier 13, provided with an ink head 12 that discharges the colors C (Cyan: blue), M (Magenta: red), Y (Yellow), and K (black) in a transverse direction of the frame 11, perpendicularly to the feeding direction of the printing material 15. Here, the carrier 13 is moved along a conveying axis 14 by a drive motor (not shown).

However, while a conventional inkjet printer 10 discharges ink onto paper material 15 with a white background fed from the rear to print characters, images, colors, etc., the problem of this type of paper material being generally unsuitable for outdoor advertisements exists.

While this problem can be overcome by using solvent ink directly printed on vinyl, PVC or other material, because a characteristic of solvent in solvent ink is that it emits a large amount of volatile odor that degrades a work environment, and because solvent ink discharged onto vinyl or PVC material cannot be absorbed by the material, a small quantity of ink must be discharged and dried through natural drying, so that there is the problem of slow printing speed of printing material.

Also, an inkjet printer 10 according to the related art also has the problem of being unable to perform printing on printing material such as flat wooden, glass, stone, or metal materials that are not configured as roll-type materials fed from the rear of the inkjet printer 10.

In addition, when an inkjet printer 10 according to the related art performs printing on material such as the above-described wooden, glass, stone, or metal materials, there is the problem of reduced ink adhesion.

Furthermore, when printing is performed on materials with low adhesion, there is the problem of lowered durability of ink due to ink running, lowered light resistance, color reproduction, and water and scratch resistance, etc.

Moreover, while a related art inkjet printer 10 is configured to maintain a uniform gap with the surface of a printing material, when the thickness of a printing material is non-uniform, the discharging surface of an ink head can contact the surface of the printing material, causing the problem of defects in printed material.

Also, if the surface of a printing material and an ink head come into contact, the problem of serious damage to the ink head arises.

In addition, when the background color of a printing material is not white—that is, in order to represent an image on a black background, if ink of a desired color is discharged onto a printing material with a white background to print the image, and the remaining regions are printed with black ink discharged thereon—an unnecessary amount of ink is consumed and printing time is lengthened.

An inkjet printer 10 according to the related art is capable of only printing, and has the problem of being unable to provide printed material that has undergone secondary processing such as cutting.

This problem can be solved by the laser cutter in FIG. 2.

As illustrated in FIG. 2, a moving frame 22 is movably installed longitudinally along a work table 21 of a laser cutter 20 by means of a drive motor (not shown).

A laser cutter 24 is installed transversely to the work table 21 to cut a cutting material 23 loaded on the work table 21 into a predetermined shape or size.

However, such a laser cutter 20 involves the problems of increased manufacturing cost and lowered yield, due to a complicated work process that includes having to perform re-processing after a printing material is printed with an inkjet printer 10.

### DISCLOSURE OF INVENTION

### Technical Problem

To solve the above problems, an object of the present invention is to provide a multifunction printer and printing method thereof that improve adhesion of ink to a printing material.

Another object of the present invention is to provide a multifunction printer and printing method thereof that prevent scattered reflection of ink after printing of printing materials and that increase durability of printed ink.

A further object of the present invention is to provide a multifunction printer and a printing method thereof capable of performing cutting of edges of printed material.

### Technical Solution

To achieve the above objects, a multifunction printer according to the present invention includes: a body frame provided with a work table; a moving frame installed to be movable along a lengthwise direction of the body frame at an upper surface of the body frame; a print head installed to be movable along a lengthwise direction at a side of the moving frame, and provided with a plurality of nozzles including a nozzle for discharging a pre-coating liquid onto a surface of a printing material, and a nozzle for discharging ink for printing an image onto the surface of the printing material or a surface of the pre-coating liquid that has been discharged; a plurality of drivers installed on the body frame and the moving frame, respectively, to move the moving frame and the print head; a dryer installed on the print head or the moving frame, for drying a coating liquid discharged onto the surface of the printing material and for hardening ink; and a controller for outputting control signals to the print head to discharge the pre-coating liquid and printing ink in accordance with printing data, and for outputting a position control signal to the drivers to move the print head to a printing position.

The print head may further include a nozzle for discharging a protective coating liquid for the surface of printed material from the printing material that has completed final printing.

The plurality of ink discharge nozzles may discharge ink of the colors Cyan, Light Cyan, Magenta, Light Magenta, Yellow, Black, White, Gold, and Silver, respectively.

The dryer may include: a heater for applying heat to and drying coating liquid and ink discharged onto the surface of the printing material; and a UV (ultraviolet) lamp for radiating UV rays onto and drying coating liquid and ink discharged onto the surface of the printing material.

The print head may include: a first head installed on the moving frame; a second head detachably installed at a side of the first head, and including the plurality of nozzles; and a driver installed at a side of the first head to move the second head upward and downward.

The multifunction printer may further include a scanner installed at a side of the print head to detect a width of a printing material atop the work table, wherein a position of the second head is set according to the thickness of the printing material detected by the scanner.

The multifunction printer may further include a laser cutter installed at a side of the print head to perform cutting along an outer perimeter of the printed material that has completed printing.

The multifunction printer may further include a roll feeder detachably installed at a side of the body frame to supply a printing material in a roll configuration to a bottom of a lower surface of the print head, wherein the roll feeder operates according to a control signal output from the controller.

A printing method for a multifunction printer according to the present invention includes the steps of: a) applying a pre-coating liquid on a surface of a printing material through a nozzle of a print head, when a request for a pre-coating of the printing material is included in printing data that includes pre-coating and image printing data; and b) discharging ink for printing an image through a nozzle of the print head, or discharging ink for printing an image through a nozzle of the print head together with the applying of the pre-coating liquid, following completion of the applying of the pre-coating liquid on the printing material, in accordance with a solvent of the pre-coating liquid.

Preferably, step b) may include the steps of: discharging the ink for printing after the completion of the applying of the pre-coating liquid, when the solvent of the pre-coating liquid is a solvent-type; and discharging the ink for printing together with the applying of the pre-coating liquid, when the pre-coating liquid is a UV hardening solvent.

The step of discharging the ink for printing after the completion of the applying of the pre-coating liquid may include the steps of: applying the pre-coating liquid while moving the nozzles of the print head from a preset reference position along the printing material; turning on a heater for drying the pre-coating liquid and returning the print head to the reference position, after elapse of a predetermined duration, when the applying of the pre-coating liquid is completed; and turning off the heater for drying when the print head is returned to the reference position, and requesting output of the ink for printing an image.

The step of discharging the ink for printing together with applying the pre-coating liquid, may include the steps of: turning on a UV hardening lamp simultaneously with applying the pre-coating liquid while moving nozzles of the print head from a preset reference position across the printing material; printing an image through requesting output of the ink for printing an image and discharging the ink for printing through a nozzle of the print head; and turning off the UV hardening lamp and returning to the reference position, when the applying of the pre-coating liquid and the discharging of the ink for printing an image are completed.

The step of discharging the ink for printing together with applying the pre-coating liquid may further include the steps of sequentially discharging the pre-coating liquid, the ink for printing, and a finish coating liquid onto the surface of the printing material through nozzles when a request is made for finish coating the printing material.

The printing method for a multipurpose printer according to the present invention may further include discharging a finish coating liquid onto the surface of the printing material through a nozzle when a request is made for finish coating the printing material that has undergone step b) of discharging the ink for printing.

The discharging of the finish coating liquid may include the steps of: discharging the finish coating liquid while moving nozzles of the print head along the printing material from the preset reference position; turning on at least one of a heater for drying finish coating liquid and a UV lamp, and returning the print head to the reference position, after elapse of a predetermined duration upon completion of the discharging of the finish coating liquid; and completing the discharging of the finish coating when the print head returns to the reference position.

Step a) may further include the steps of: d) scanning to detect a thickness of the printing material; and e) adjusting a height of the nozzles according to the detected thickness of the printing material.

Step b) of discharging ink for printing an image may include the step of performing at least one printing of a basic printing, a white printing, a spot color printing, a front printing, and a background printing.

The printing method may further include the step of f) cutting through performing cutting along an outer perimeter of the printed image, after completion of printing.

### Advantageous Effects

Accordingly, a multifunction printer according to the present invention has the advantage of being able to provide printed material with improved adhesion of ink printed thereon, regardless of the type of printed material.

Another advantage of the present invention is that the durability of discharged ink can be increased through protecting by coating printed material.

A multifunction printer according to the present invention also has the advantage of being able to provide uniform color reproduction on a printed material by preventing scattered reflection of ink through coating.

A further advantage of the present invention is that processing time and manufacturing cost can be reduced by enabling cutting to be performed with printing.

A still further advantage is that manufacturing efficiency and work spaces can be effectively improved together with reduction of processing time and manufacturing cost.

### BRIEF DESCRIPTION OF DRAWINGS

FIG. 1 is a perspective view of a related art inkjet printer.

FIG. 2 is a perspective view of a related art laser cutter.

FIG. 3 is a schematic perspective view of a multifunction printer according to an embodiment of the present invention.

FIG. 4 is a block diagram illustrating the configuration of the multifunction printer in FIG. 3.

FIG. 5 is a plan view illustrating the configuration of a head unit of the multifunction printer in FIG. 3.

FIG. 6 is a perspective view illustrating a drying unit installed on a moving frame of the multifunction printer in FIG. 3.

FIG. 7 is a sectional view illustrating a thickness measuring process of a printing material in the multifunction printer in FIG. 3.

FIG. 8 is a sectional view of a printing material printed by the multifunction printer in FIG. 3.

FIG. 9 is a sectional view of another printing material printed by the multifunction printer in FIG. 3.

FIG. 10 is a sectional view of a multifunction printer according to another embodiment of the present invention.

FIG. 11 is a flowchart of a printing process for a multifunction printer according to the present invention.

FIG. 12 is a flowchart of a pre-coating process for the multifunction printer in FIG. 11.

FIG. 13 is a flowchart of a finish coating process for the multifunction printer in FIG. 11.

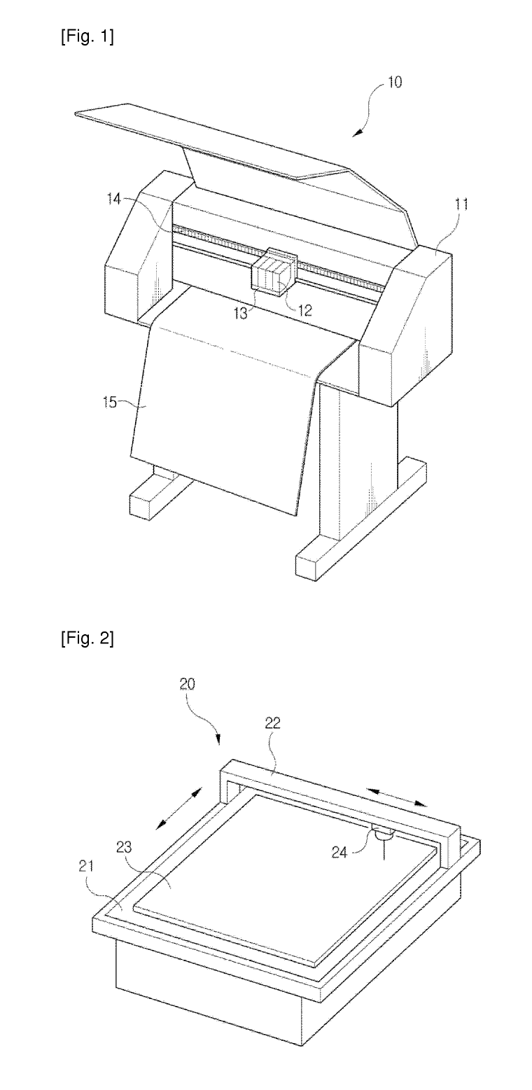

### BEST MODE FOR CARRYING OUT THE INVENTION

Below, a description of preferred embodiments of the present invention will be provided as follows, with reference to the attached diagrams.

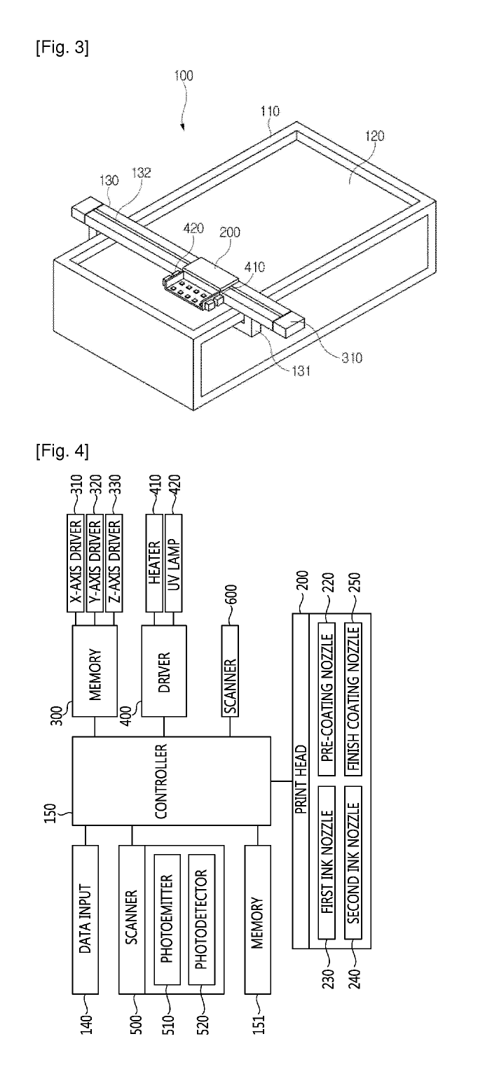

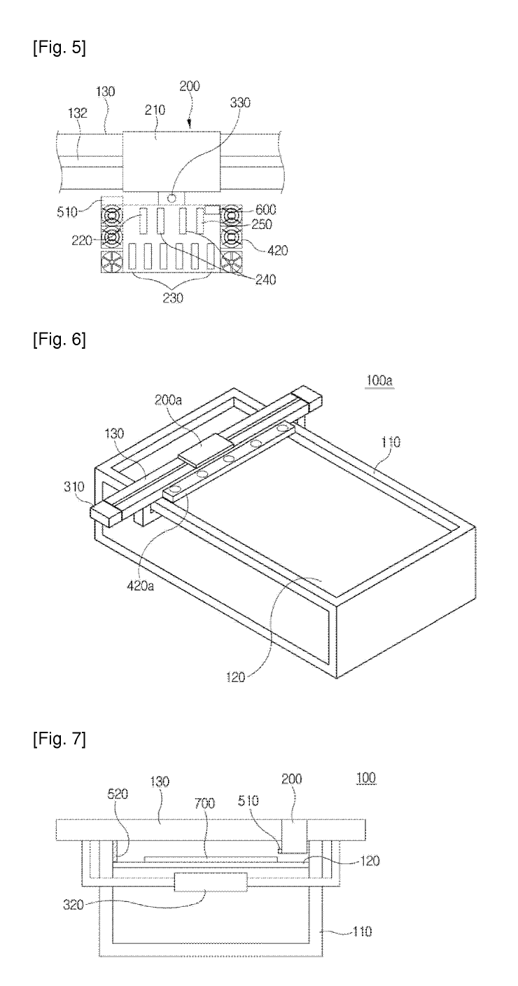

FIG. 3 is a schematic perspective view of a multifunction printer according to an embodiment of the present invention, FIG. 4 is a block diagram illustrating the configuration of the multifunction printer in FIG. 3, FIG. 5 is a plan view illustrating the configuration of a head unit of the multifunction printer in FIG. 3, FIG. 6 is a perspective view illustrating a drying unit installed on a moving frame of the multifunction printer in FIG. 3, and FIG. 7 is a sectional view illustrating a thickness measuring process of a printing material in the multifunction printer in FIG. 3.

Referring to FIGS. 3 through 7, a multifunction printer 100 according to the present invention includes a rectangular body frame 110, a moving frame 130 that moves along a longitudinal direction of the body frame 110 at the top of the body frame 110, a print head 200 provided with a plurality of nozzles 220, 230, 240, and 250 that discharge a pre-coating liquid, ink for printing images, and a finish coating liquid, a plurality of drivers 310, 320, and 330 for moving the moving frame 130 and the print head 200, a dryer 400 for drying the discharged pre-coating liquid, ink for printing images, and finish coating liquid, a controller 150 for controlling printing of printing material through discharging the pre-coating liquid, ink for printing images, and the finish coating liquid, in accordance with printed data input through a data input 140, a scanner 500 for measuring the thickness of a printing material 700, and a laser cutter 600 for performing cutting along an outer perimeter of a printed material after printing has been completed.

The body frame 110 includes a work table 120 of a hollow, rectangular shape and having the printing material 700 installed at an upper portion thereof.

The moving frame 130 is installed to be capable of moving along the longitudinal direction of the body frame 110 at the upper surface of the body frame 110.

A supporting frame 131 is installed beneath the body frame 130 and connected to a Y-axis driver 320 installed on the body frame 110 to transmit driving force from the Y-axis driver 320 to the moving frame 130.

Also, an X-axis guide 132 is installed along the longitudinal inside of the moving frame 130 to guide the printer head 200 to moved along the longitudinal direction of the moving frame 130.

The data input 140 is installed at a side within the body frame 110, receives printing data from an external device such as a computer, portable storage device, or a key input unit, etc., and the received printing data is transmitted to the controller 150.

The printing data includes data including data on whether to perform a pre-coating of a printing material and whether to perform basic printing, white color printing, spot color printing, front printing, and background printing, data on whether to perform finish coating when image printing has been completed, and data on whether to perform cutting of printed material.

The printing data may further include data displaying the solvent for pre-coating liquid, the solvent for ink, and the solvent for finish coating liquid.

Basic printing employs the colors Cyan, Light Cyan, Magenta, Light Magenta, Yellow, and Black, spot color printing employs the colors gold and silver, and white color printing, front printing, and background printing employs the color white.

Basic printing may employ additional colors selected by a user other than those listed above.

The controller 150 is configured to control the overall operation of the multifunction printer 100, so that when printing data is input through the data input 140, the controller interprets the input printing data to determine whether to perform operations of printer settings, pre-coating, image printing, finish coating, and cutting, outputs control signals to corresponding nozzles 220 through 250 in accordance with the analysis results, and outputs control signals for operating the X-axis, Y-axis, and Z-axis drivers 310 through 330 to the driver 300.

The controller 150 also outputs ON/OFF control signals to the dryer 400, based on the discharged solvent and the printing process.

The controller 150 is further provided with a spool memory 151 that stores printing data input through the data input 140, in order to prevent delays in printing due to processing standby between the controller 150 that operates quickly and the print head 200 and driver 300 that operate slowly.

The print head 200 includes a first head 210 installed to be capable of moving along a longitudinal direction of the moving frame 130, a plurality of discharge nozzles 220, 230, 240, and 250 detachably formed on the first head 210, and a second head 211 with the dryer 400 installed thereon.

The first head 210 has a [symbol] -shaped cross section, an undersurface at one side of the first head 210 contacts the upper surface of the moving frame 130 to move the first head 210 along a longitudinal direction of the moving frame 130 according to the driving force imparted by the X-axis driver 310, and the Z-axis driver 330 is installed at the other side to drive the second head 211 upward or downward.

The second head 211 has a [symbol] -shaped cross section, one side of the second head 211 is connected to the Z-axis driver 330, and the plurality of discharge nozzles 220, 230, 240, and 250 is connected to the other side thereof.

Of the plurality of discharge nozzles 220, 230, 240, and 250, when a pre-coating nozzle 220 operates according to a control signal output from the controller 150, pre-coating liquid is discharged onto the surface of a printing material 700.

The pre-coating liquid increases adhesion of ink discharged onto the printing material through making printing materials with non-uniform surfaces more uniform to enable uniform color reproduction of ink after printing.

Printing materials include materials that can be printed, such as printing paper, metal, glass, cloth, and synthetic resins.

The pre-coating liquid is a primer, employing one of a solvent type primer and a UV hardening primer.

The first ink nozzle 230 operates according to a control signal output from the controller 150, and discharges ink for printing an image onto a surface of a printing material 700 or a surface of a formerly discharged pre-coating liquid.

The first ink nozzle 230 has a nozzle configured to be capable of discharging ink of at least four colors including Cyan, Magenta, Yellow, and Black, and in the present embodiment, is configured to be capable of discharging 6 colors including Cyan (C), Light Cyan, Magenta (M), Light Magenta, Yellow (Y), and Black (K).

The discharged ink for printing employs one of a solvent ink and a UV hardening ink.

The second ink nozzle 240, as a nozzle for discharging ink of spot colors selected in addition to the main printing colors by a user, operates according to a control signal output from the controller 150 to discharge ink together with or separately from ink for printing an image discharged through the first ink nozzle 230.

That is, it includes at least one or more of the colors white, gold, and silver for providing front printing, background printing, or spot color printing in addition to basic printing for printing an image, and other colors may be added via selection by a user.

The finish coating nozzle 250 operates according to a control signal from the controller 150 to discharge a finish coating liquid onto the surface of a final printed material which has completed printing of an image.

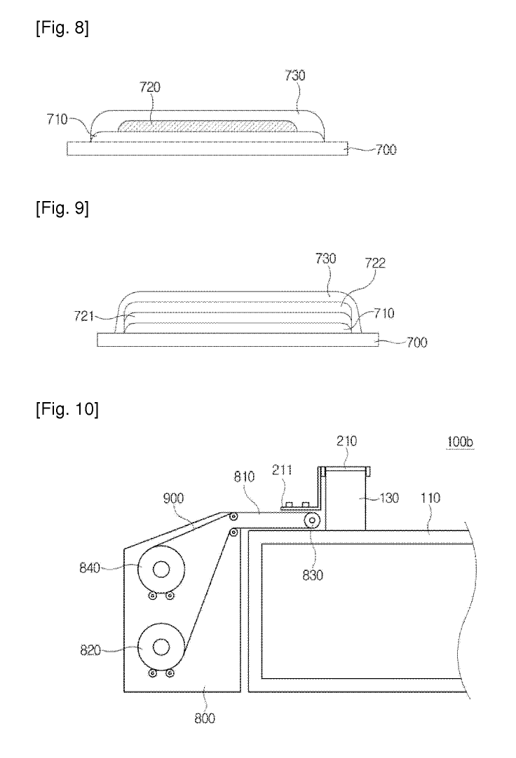

That is, as illustrated in FIG. 8, a pre-coating layer 710 is formed on the surface of a printing material 700, a color printing layer 720 for printing an image is formed on the upper surface of the pre-coating layer 710, after which a finish coating layer 730 is formed to protect the color printing layer 720.

Also, as illustrated in FIG. 9, a pre-coating layer 710 is formed on the surface of a printing material 700, and a color printing layer 721 for basic printing or background printing, or a white color printing layer 721 for front printing is formed on the upper surface of the pre-coating layer 710.

When the color printing layer 721 for a basic printing or a background printing is formed, after a color printing layer 722 of spot colors or white is formed, the finish coating layer 730 is formed.

Also, when the color printing layer 721 for front printing is formed, after color printing layers 722 of various colors (for printing an image) are formed, the finish coating layer 730 is formed.

Thus, a finish coating liquid discharged onto the finish coating layer 730 not only improves ink durability, but also protects the surface of a printed material from scratches, etc., and makes the surface of the printed material uniform, thereby preventing scattered reflection of ink.

The finish coating liquid employs one of a solvent coating liquid and a UV hardening coating liquid.

Referring again to FIGS. 3 through 7, the driver 300 operates according to a control signal output from the controller 150, and may include an X-axis driver 30, a Y-axis driver 320, and a Z-axis driver 330.

The X-axis driver 310 is installed at one end of the moving frame 130 to provide driving force to move the print head 200 along the longitudinal direction of the moving frame 130 in accordance with an X-axis drive control signal output from the controller 150.

The Y-axis driver 320 is installed inside the body frame 110 to provide driving force to move the moving frame 130 along a longitudinal direction of the body frame 110 in accordance with a Y-axis drive control signal output from the controller 150.

The Z-axis driver 330 is installed on the first head 210 of the print head 200 to provide driving force to move the second head 211 in upward and downward directions of the first head 210 in accordance with a Z-axis drive control signal output from the controller 150.

Here, driving force transferring means of the X-axis, Y-axis, and Z-axis drivers 310, 320, and 330 employ well-known configurations.

The dryer 400 is installed on one or both sides of the second head 211 of the print head 200 to dry a pre-coating liquid, ink for printing an image, and finish coating liquid discharged through the nozzles 220 through 250, and operates according to a dryer control signal output from the controller 150. The dryer 400 may include a heater 410 that radiates heat, and a UV lamp 420 that radiates ultraviolet (UV) rays.

When solvent liquid is discharged through the nozzles 220 through 250, the heater 410 operates to perform drying through heat.

Here, the heater 410 may be installed as a hot wire and ventilator combination, may be installed to employ a halogen lamp that radiates high heat, and may preferably be installed as a halogen lamp.

When UV hardening solvent is discharged through the nozzles 220 through 250, the UV lamp 420 operates to perform hardening through UV rays.

Here, one of a UV lamp and a UV LED is installed in the UV lamp 420, and preferably, a UV LED is installed.

While in the present embodiment, the UV lamp 420 of the dryer 400 is installed at either side of the print head 200, in the multifunction printer 100a illustrated in FIG. 6, a print head 200a may be installed at a front of the moving frame 130, and a UV lamp 420a may be installed at a rear of the moving frame 130.

Here, one of a UV lamp and a UV LED is installed in the UV lamp 420a, and preferably, a tube-shaped UV lamp is installed.

The scanner 500 is for measuring the thickness of a printing material atop the work table 120, in order to prevent the nozzles 220 through 250 installed on the print head 200 to be pressed against the surface of the printing material 700 and causing damage of the nozzles 220 through 250.

The scanner 500 according to the present embodiment includes a photoemitter 510 installed at one side of the second head 211 of the print head, and a photodetector 520 installed at one side of the body frame 110 facing the photoemitter 510.

The photoemitter 510 moves along the longitudinal direction of the body frame 110 and radiates, for example, infrared rays from a side of the second head 211 toward the photodetector 520, and the photodetector 520 receives the infrared rays radiated from the photoemitter 510 and outputs the data to the controller 150.

Specifically, the controller 150 detects whether light radiated from the photoemitter 510 is received by the photodetector 520 to determine the thickness of a printing object 700, and sets the second head 211 accordingly at a suitable position.

When the photoemitter 510 and the photodetector 520 are installed on the second head 211 and light for measuring thickness is radiated from the photoemitter 510 onto a surface of a printing material 700, the photodetector 520 detects light reflected from the surface of the printing material 700 and the controller analyzes the data to thus enable the thickness of the printing material 700 to be detected.

The laser cutter 600 is installed at the second head 211 of the print head to perform cutting of printed material that has completed printing, and performs cutting along the perimeter of the printed material.

A laser cutter 600 according to the present embodiment may be configured as a CO₂ laser generator, or may be configured as a well-known laser cutter.

As illustrated in FIG. 10, the multifunction printer 100b of the present invention may be configured to further include a roll feeder 800 at a side thereof.

Configured for feeding a printing material 900 wound in a roll to the multifunction printer 100b, the roll feeder 800 is detachably installed at a side of the body frame 110.

Also, the roll feeder 800 includes a projecting portion 810 extending a predetermined distance enabling the printing material to be supplied to the bottom of the lower surface of the print head 200, a supplying roller 820 supplying the printing material 900, a feeding roller 830 for feeding the printing material 900 to the print head 200, and a winding roller 840 winding and collecting the printing material 900 after it has completed printing.

When the roll feeder 800 contacts a side of the body frame 110, the controller 150 sequentially outputs operation control signals to the supplying roller 820 and the winding roller 840 in order to print an image on the printing material 900.

Next, a printing process for a multifunction printer according to the present invention will be described.

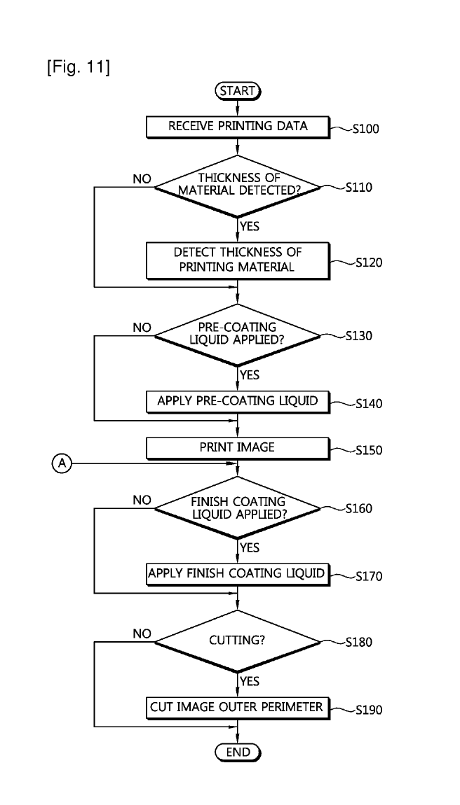

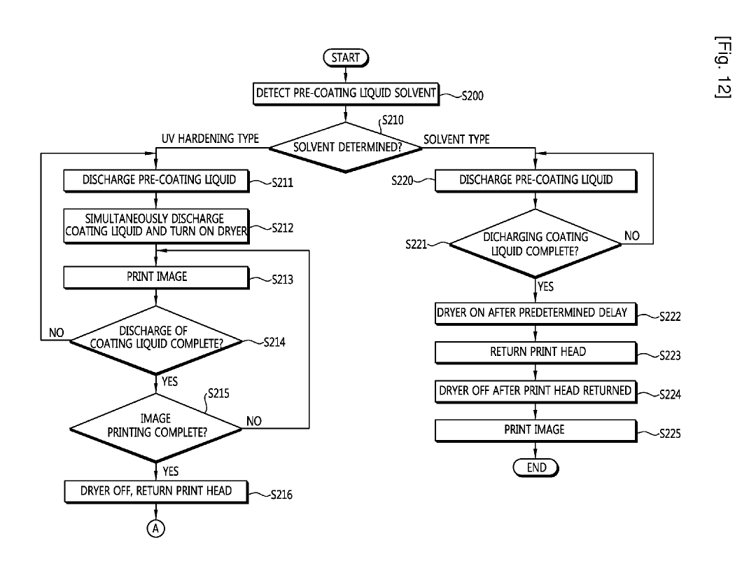

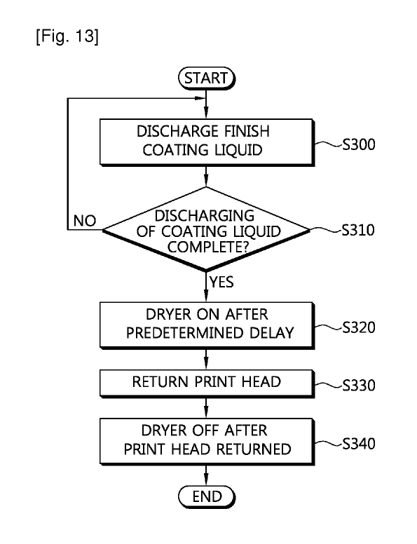

FIG. 11 is a flowchart of a printing process for a multifunction printer according to the present invention, FIG. 12 is a flowchart of a pre-coating process for the multifunction printer in FIG. 11, and FIG. 13 is a flowchart of a finish coating process for the multifunction printer in FIG. 11.

Referring to FIGS. 3 through 13, in a printing method for a multifunction printer according to the present invention, the controller 150 of the multifunction printer 100 receives printing data input through the data input 140 in operation S100 and stores the data in the memory 151, and analyzes the received data and performs printing according to the results.

The printing data received in operation S100 includes pre-treating data including whether to measure the thickness of a printing material prior to performing printing and whether to discharge pre-coating liquid, image printing data including color and position data for an image for basic printing, front printing, background printing, and spot color printing data, and finish coating data including whether to discharge a finish coating liquid after completion of printing and whether to perform cutting.

The controller 150 determines in operation S110 whether data for measuring the thickness of a printing material is included in the pre-coating data received in operation S100, outputs control signals for the X-axis and Y-axis drivers 310 and 320 together with a control signal for the Z-axis driver 330 in order to position the print head 200 in a preset location when it is determined that measuring of the thickness of the printing material is requested, and moves the print head 200 to measure the height of the printing material 700 in operation S120 after the print head 200 has been positioned in the preset location.

If the thickness of the printing material measured in operation S120 is found to be greater than a preset height, the controller 150 outputs a control signal to the Z-axis driver 330 to change the height of the print head 200. Here, the varied height of the print head 200 is set as the print head 200 height when performing subsequent printing of printing material.

According to a user's preferences, operations S110 and S120 may be removed.

The controller 150 determines in operation S130 whether a request was made in the pre-coating data of the printing data for discharging of a pre-coating liquid, and discharges a pre-coating liquid through a pre-coating nozzle 220 onto the surface of a printing material in operation S140, when it is determined that there was a request for discharging a pre-coating liquid.

If there was no request in operation S130 for discharging of a pre-coating liquid, image printing is performed in operation S150 by discharging required ink colors through the first and second ink nozzles 230 and 240.

Operation S150 of discharging ink of required colors to print an image includes the performing of basic printing using Cyan, Light Cyan, Magenta, Light Magenta, Yellow, and Black, front printing or background printing using the color white, and spot color printing with gold and silver, according to user settings.

Operation S140 is performed as described below according to solvents for the pre-coating liquid and the ink for printing an image.

The controller 150 detects whether the solvents for the pre-coating liquid and printing ink are a solvent or a UV hardener in operation S200, and determines in operation S210 whether they are UV hardeners or solvents.

Determination in operation S210 of whether the solvents are a UV hardener or a solvent may be made through receiving solvent data through the data input 140 or receiving preset solvent data.

In operation S210, when the pre-coating liquid is a UV hardening solvent, the controller 150 moves the print head 200 to a preset reference position, outputs a control signal in operation S211 to discharge a pre-coating liquid through the pre-coating nozzle 220, and turns on the UV lamp 420 of the dryer 400 in operation S212 to harden the discharged pre-coating liquid.

Also, the controller 150 requests data for image printing from the printing data stored in the memory 151, and outputs a control signal in operation S213 for discharging ink for printing an image through the first and second ink nozzles 230 and 240, to perform the same printing as the image printing in operation S150.

The controller 150 determines in operation S214 whether discharging of the pre-coating liquid has ended, and if the pre-coating liquid discharging has ended, determines in operation S215 whether printing of an image has ended. If printing has ended, the UV lamp 420 of the dryer is turned off, and the print head 200 that moves to perform printing returns to its reference position in operation S216.

If discharging of pre-coating liquid is found not to have ended in operation S214, operations S211 and S213 are performed again.

If image printing is found not to have ended in operation S215, operation S213 is performed again.

If the pre-coating liquid and the printing ink are UV hardening solvents, the finish coating liquid can also employ UV hardening solvent, and when finish coating liquid discharge data is included, pre-coating liquid, printing ink, and finish coating liquid may sequentially be discharged to perform 3 operations—pre-coating, image printing, and finish coating—with one movement.

In operation S210, when the pre-coating liquid is a solvent-type, the controller 150 moves the print head 200 to the preset reference position, and moves the print head from the reference position along the printing material to discharge pre-coating liquid in operations S220 and S221 until the discharging of the pre-coating liquid is completed.

When the pre-coating liquid discharging is completed, the controller 150 waits a pre-determined duration to allow sufficient diffusion of the discharged pre-coating liquid, and then turns on the heater 410 for the pre-coating dryer in operation S222, after which the print head 200 is returned in operation S223 to the reference position.

When the print head 200 is returned to the reference position, the controller 150 turns off the heater 410 of the dryer in operation S224, and outputs control signals to the first and second ink nozzles to discharge ink for printing an image in operation S225, thus performing the same type of image printing in operation S150.

To describe a printing process for a multifunction printer with reference to FIG. 11 again, when discharging of the pre-coating liquid and the printing ink are completed, the controller 150 determines in operation S160 whether there is a request for a finish coating on the printed material that has completed printing, and if there is a request for a finish coating, discharges a finish coating liquid onto the printing material 700 in operation S170.

To describe the discharging of the finish coating liquid in operation S170 in further detail, as illustrated in FIG. 13, the controller 150 moves the print head to the preset reference position, and moves the print head from the reference position across the printing material 700 while discharging finish coating liquid in operations S300 and S310 until discharging of the finish coating is completed.

The finish coating liquid used may be either one of a solvent-type and a UV hardening-type.

When discharging of the finish coating liquid is completed, the controller 150 waits a certain duration to allow sufficient diffusion of the discharged finish coating liquid over the surface of the printing material 700, and turns on at least one of the heater 410 for drying finished coating liquid and the UV lamp 420 in operation S320, after which the print head 200 is returned to the reference position in operation S330.

When the print head 200 returns to the reference position, the controller 150 turns the heater 410 or the UV lamp 420 off, and ends the finish coating process in operation S340.

To describe a printing process for a multifunction printer with reference to FIG. 11, when discharging of the finish coating liquid has been completed, the controller 150 determines in operation S180 whether there is a request for completion of the finish coating liquid discharging or for cutting a printed material that has completed image printing, and when there is a request to perform cutting, the controller 150 outputs a control signal to the driver 300 and the laser cutter 600 so that the laser cutter 600 installed at a side of the print head 200 performs, in operation S190, cutting along the outer perimeter of the printing material 700 that has completed printing or completed finish coating.

While not shown, if the roll feeder 800 is brought into contact by means of a contacting member installed at one side of the body frame 110, the controller 150 performs image printing based on printing data input through the data input 140, and outputs control signals to operate the supplying roller 820 and the winding roller 840 when printing is performed.

Accordingly, pre-coating, finish coating, and spot color printing are made possible, printing can be performed regardless of the color, form, or material of the printing material, and cutting can also be performed together, once printing has been completed.

Specific preferred embodiments of the present invention have been illustrated and described above. However, the present invention is not limited to only the embodiments described above, and those having ordinary skill in the art will readily be able to devise various alternate embodiments that fall within the technical spirit and scope of the present invention, as outlined in the appended claims below.

1. A multifunction printer comprising:
a body frame provided with a work table;
a moving frame installed to be movable along a lengthwise direction of the body frame at an upper surface of the body frame;
a print head installed to be movable along a lengthwise direction at a side of the moving frame, and provided with a plurality of nozzles including a nozzle for discharging a pre-coating liquid onto a surface of a printing material, and a nozzle for discharging ink for printing an image onto the surface of the printing material or a surface of the pre-coating liquid that has been discharged;
a plurality of drivers installed on the body frame and the moving frame, respectively, to move the moving frame and the print head;
a dryer installed on the print head or the moving frame, for drying a coating liquid discharged onto the surface of the printing material and for hardening ink; and
a controller for outputting control signals to the print head to discharge the pre-coating liquid and printing ink in accordance with printing data, and for outputting a position control signal to the drivers to move the print head to a printing position.

2. The multifunction printer of claim 1, wherein the print head further includes a nozzle for discharging a protective coating liquid for the surface of printed material from the printing material that has completed final printing.

3. The multifunction printer of claim 1, wherein the plurality of ink discharge nozzles discharge ink of the colors Cyan, Light Cyan, Magenta, Light Magenta, Yellow, Black, White, Gold, and Silver, respectively.

4. The multifunction printer of claim 1, wherein the dryer comprises:
a heater for applying heat to and drying coating liquid and ink discharged onto the surface of the printing material; and
a UV (ultraviolet) lamp for radiating UV rays onto and drying coating liquid and ink discharged onto the surface of the printing material.

5. The multifunction printer of claim 1, wherein the print head comprises:
a first head installed on the moving frame;
a second head detachably installed at a side of the first head, and including the plurality of nozzles; and
a driver installed at a side of the first head to move the second head upward and downward.

6. The multifunction printer of claim 5, further comprising a scanner installed at a side of the print head to detect a width of a printing material atop the work table, wherein a position of the second head is set according to the thickness of the printing material detected by the scanner.

7. The multifunction printer of claim 5, further comprising a laser cutter installed at a side of the print head to perform cutting along an outer perimeter of the printed material that has completed printing.

8. The multifunction printer of claim 5, further comprising a roll feeder detachably installed at a side of the body frame to supply a printing material in a roll configuration to a bottom of a lower surface of the print head, wherein the roll feeder operates according to a control signal output from the controller.

9. A printing method for a multifunction printer, the printing method comprising the steps of:
a) applying a pre-coating liquid on a surface of a printing material through a nozzle of a print head, when a request for a pre-coating of the printing material is included in printing data that includes pre-coating and image printing data; and
b) discharging ink for printing an image through a nozzle of the print head, or discharging ink for printing an image through a nozzle of the print head together with the applying of the pre-coating liquid, following completion of the applying of the pre-coating liquid on the printing material, in accordance with a solvent of the pre-coating liquid.

10. The printing method of claim 9, wherein step b) comprises the steps of:
discharging the ink for printing after the completion of the applying of the pre-coating liquid, when the solvent of the pre-coating liquid is a solvent-type; and
discharging the ink for printing together with the applying of the pre-coating liquid, when the pre-coating liquid is a UV hardening solvent.

11. The printing method of claim 10, wherein the step of discharging the ink for printing after the completion of the applying of the pre-coating liquid comprises the steps of:
applying the pre-coating liquid while moving the nozzles of the print head from a preset reference position along the printing material;
turning on a heater for drying the pre-coating liquid and returning the print head to the reference position, after elapse of a predetermined duration, when the applying of the pre-coating liquid is completed; and
turning off the heater for drying when the print head is returned to the reference position, and requesting output of the ink for printing an image.

12. The printing method of claim 10, wherein the step of discharging the ink for printing together with applying the pre-coating liquid, comprises the steps of:
turning on a UV hardening lamp simultaneously with applying the pre-coating liquid while moving nozzles of the print head from a preset reference position across the printing material;
printing an image through requesting output of the ink for printing an image and discharging the ink for printing through a nozzle of the print head; and
turning off the UV hardening lamp and returning to the reference position, when the applying of the pre-coating liquid and the discharging of the ink for printing an image are completed.

13. The printing method of claim 12, wherein the step of discharging the ink for printing together with applying the pre-coating liquid further comprises the steps of sequentially discharging the pre-coating liquid, the ink for printing, and a finish coating liquid onto the surface of the printing material through nozzles when a request is made for finish coating the printing material.

14. The printing method of claim 9, further comprising the step of c) discharging a finish coating liquid onto the surface of the printing material through a nozzle when a request is made for finish coating the printing material that has undergone step b) of discharging the ink for printing.

15. The printing method of claim 14, wherein the discharging of the finish coating liquid comprises the steps of:
discharging the finish coating liquid while moving nozzles of the print head along the printing material from the preset reference position;
turning on at least one of a heater for drying finish coating liquid and a UV lamp, and returning the print head to the reference position, after elapse of a predetermined duration upon completion of the discharging of the finish coating liquid; and
completing the discharging of the finish coating when the print head returns to the reference position.

16. The printing method of claim 10, wherein step a) further comprises the steps of:
d) scanning to detect a thickness of the printing material; and
e) adjusting a height of the nozzles according to the detected thickness of the printing material.

17. The printing method of claim 9, wherein step b) of discharging ink for printing an image comprises the step of performing at least one printing of a basic printing, a white printing, a spot color printing, a front printing, and a background printing.

18. The printing method of claim 9, further comprising the step of cutting through performing cutting along an outer perimeter of the printed image, after completion of printing.
